(19) United States
(12) Patent Application Publication
(10) Pub. No.: US 2001/0018284 A1
(43) Pub. Date: Aug. 30, 2001

(54) Method for assembly of a cable connector assembly with coupling nut

(75) Inventor: Frank Kendall Porter JR., Billerica, MA (US)

Correspondence Address: Herbert L. Bello, One Hollis Street, Wellesley, MA, 02482, US

(73) Assignee: Tensolite Company

(21) Appl. No.: 09/847,640

(22) Filed: May 2, 2001

Related U.S. Application Data
(62) Division of application No. 09/359,091, filed on Jul. 22, 1999.

(51) Int. Cl. H01R 4/38

(52) U.S. Cl. 439/320

(57) ABSTRACT

A connector assembly for interconnection with a mating connector includes a body, a locking nut, and a restraining element. The restraining element rotatably secures the locking nut on the body of the connector assembly. The restraining element can have an annular configuration and be elastically deformable. When this configuration is utilized, the body typically includes a ramp with a groove in juxtaposition thereto. The ramp facilitates both deformation and placement of the restraining element in the groove of the body. Alternatively, the restraining element can have a substantially rigid, tubular configuration and include a flange sized and shaped to engage a portion of the locking nut. This later configuration of the restraining element is designed to be interferingly positioned on the body of the assembly. Also disclosed is a tubular tool element configured to be capable of exerting a substantially equal force upon the restraining element during manufacture of the disclosed connector assembly. The tool element is utilized to align and secure the restraining element on the body during the manufacturing process.

### BACKGROUND OF THE INVENTION

1. Field of the Invention

The present invention relates to electrical connectors and, more particularly, is directed toward a cable connector assembly having a coupling nut for securing two mating connector assemblies together and a method for manufacturing the cable assembly.

2. Description of the Prior Art

Electrical applications require connector assemblies capable of coupling both wire and cable with minimal detriment to electrical efficiency and signal transmission.

A wide variety of mating connector assemblies are currently available in the prior art. Generally, one of the connector assemblies includes a connector body with a locking nut rotatably positioned thereon and the other connector assembly has an externally threaded body that is configured to receive the locking nut for securing the mating connector assemblies. The connector bodies provide a terminus for the wire or cable used in a given application. The locking nut permits interconnection of the terminus of one wire or cable, i.e., the body portion of one connector assembly, to the terminus of another wire or cable, i.e., the body portion of another connector assembly.

In order to provide the desired interconnection, the locking nut must be securely positioned on the body portion of the connector assembly. In the prior art, the locking nut is typically positioned on the body using, for example, an expandable C-ring. When fully assembled, the C-ring is typically positioned in a pair of axially aligned grooves. That is, the C-ring is captured within grooves cut into the body portion and locking nut of the connector assembly. Heretofore, as discussed below, the positioning of the coupling nut on the cable assembly has been tedious and time consuming.

Different techniques are typically utilized to manufacture those connector assemblies currently available in the prior art. Although effective, each method suffers from significant limitations that impact on the mechanical and operational characteristics of available connector assemblies.

In one technique, the locking nut is held to the connector body by means of a C-ring that is inserted through a rectilinear aperture formed in the side of the locking nut. Typically, the rectilinear aperture in the locking nut causes a significant decrease in the overall mechanical strength of the locking nut. In particular, the locking nut can become susceptible to failure as a result of the exertion of shearing or torsional forces.

In another technique, the locking nut is positioned on the body of the connector assembly. A C-ring is compressed and inserted into the locking nut from the back end of the connector assembly. The compressed C-ring is positioned in alignment with grooves in the connector body and locking nut. Once aligned, the C-ring is released. This technique also requires significant mechanical manipulation of the connector assembly during manufacture. In particular, the C-ring must be kept compressed, and the body/ring combination inserted into the locking nut quickly, so that the C-ring will not expand before it is placed in the locking nut. Should the C-ring expand before placement in the locking nut, the components will not lock together as required. Further, if the components are not aligned properly during the insertion step, the body and the locking nut can become jammed together. This later condition will prevent the locking nut from rotating as desired and impairing the value of the resulting connector assembly.

A need exists for an improved apparatus and method that does not suffer from the limitations and disadvantages of prior devices. In particular, a need exists for an improved wire or cable connector assembly and an efficient method for the manufacture thereof.

### SUMMARY OF THE INVENTION

It is an object of the present invention to provide a connector assembly and a method for the manufacture thereof which does not suffer from the foregoing disadvantages and limitations.

It is another object of the present invention to provide an improved cable connector assembly having a coupling nut for securing two mating connector assemblies together.

It is a further object of the present invention to provide a method that facilitates the manufacture of a cable connector assembly having a locking nut for securing two mating connector assemblies together.

It is yet another object of the invention to provide an apparatus and method that can be used with a variety of wire or cable substrates.

It is yet a further object of the invention to provide an apparatus for interconnecting wire or cable that is simple in construction and compact in design.

It is still yet another object of the present invention to provide an apparatus for interconnecting wire or cable that is easily and economically produced, and readily assembled.

It is still yet a further object of the present invention to provide a method that facilitates the automated manufacture of a cable connector having a locking nut by securing the locking nut to the connector by means of a restraining element that is inserted through the front end of the connector.

Other general and specific objects of the invention will in part be obvious and will in part appear hereinafter.

The invention is generally characterized by a connector assembly having a body, a locking nut, and a restraining element. The connector assembly of the present invention is configured so as to be matingly engaged and disengaged from a complementary connector assembly.

The body of the connector assembly of the invention generally has two ends. One end of the body is free and can be connected to the body portions of other complementarily configured connector assemblies. The other end of the body is connected to a wire or cable as desired. The body can have a variety of configurations depending on the embodiment of the invention utilized.

In one embodiment of the invention, the body includes a ramp and a groove element. Preferably, the ramp has a frusto-conical configuration. More particularly, the ramp has a first portion and a second portion. The first portion is typically formed in the free end of the body. The first portion generally has a cross-sectional dimension that is smaller than the cross-sectional dimension of the second portion. The groove element is formed in the second portion of the ramp. Preferably, the groove element is dimensioned such that its size is intermediate that of the first portion of the ramp and the second portion of the ramp.

In another embodiment of the invention, the body has a substantially uniform cross-sectional configuration. In this embodiment, the body is sized such that it can frictionally engage the restraining element which is discussed in detail below. The body includes a groove element that is configured to receive a washer having an annular configuration. The washer functions to assist in forming a watertight or gas-tight seal. The washer can also function to prevent the migration of debris into the connector assembly of the invention. The washer is elastically deformable so that it may be easily positioned in the groove element.

The locking nut is captively held on the body. The locking nut generally has an open end and a closed end. The open end permits joining of the connector assembly of the invention to a complementarily configured connector assembly. The closed end is typically configured to engage the body of the connector assembly of the invention. More particularly, the closed end of the locking nut generally has an inwardly extending flange that interacts with the body and restraining element to rotatably and captively secure the locking nut on the body.

The restraining element can have a variety of configurations depending upon the type of body employed in a given embodiment of the invention.

In one embodiment of the invention, the restraining element has an annular configuration and is composed of a substantially rigid, elastically deformable material that is deformable from a relaxed state to an expanded state. This configuration for the restraining element is typically utilized in connection with an embodiment of the invention in which the body has a ramp and groove element as described above. In this configuration, the restraining element is sized and shaped such that when it is in its relaxed state it can be received on the first portion of the ramp of the body. The restraining element is slidable on and along the ramp and, as it does so, the restraining element typically expands from its relaxed state to its expanded state. The restraining element contracts back toward its relaxed state when it is moved into the groove element. Thus, when the connector assembly of the invention is fully assembled the restraining element is captively held in the groove element.

In an alternative embodiment of the invention, the restraining element has a configuration that is substantially identical to that of the body. Such a similarity of configuration is required so that the restraining element can be interferingly received by the body. Although this configuration of the restraining element is typically annular, virtually any configuration can be used so long as it compliments the external configuration of the body so that the restraining element and body can be frictionally engaged and fixed against relative movement. In this embodiment of the invention, the restraining element typically includes a portion that engages the flange on the locking nut as described above. In this way, the restraining element serves to secure and captively hold the locking nut in position on the body. Operationally, this embodiment of the restraining element is press-fitted onto the body such that the two components resistively engage each other.

The invention also contemplates a method for manufacturing the connector assembly of the invention. To commence the method of the invention, a body, restraining element, and locking nut having configurations as described above are obtained. The restraining element utilized will, of course, depend upon the type of body to be utilized in a given application. In the next step, the locking nut is mounted on the body. The restraining element is then coaxially and concentrically aligned with the body as required. To complete the method of the invention, the restraining element is pushed on and over the body until such time as the locking nut is rotatably restrained between the restraining element and the body.

The method of the invention further contemplates the usage of a tool element. This tool element is configured to apply a selected force to the restraining element so that the restraining element is pushed with an even and consistent force axially onto the body.

The invention accordingly comprises the steps and apparatus embodying features of construction, combinations of elements and arrangements of parts adapted to affect such steps, as exemplified in the following detailed disclosure, the scope of the invention being indicated in the accompanying claims.

### BRIEF DESCRIPTION OF THE DRAWINGS

A fuller understanding of the nature and objects of the present invention will become apparent upon consideration of the following detailed description taken in connection with the accompanying drawings in which:

FIG. 1 is a side cutaway view of a first embodiment of the connector assembly of the invention wherein the body of the connector assembly of the invention incorporates a ramp and groove element;

FIG. 2 is a side cutaway view of a second embodiment of the connector assembly of the invention wherein the restraining element is resistively held in position on the body of the connector assembly of the invention;

FIG. 3 is a side cutaway view of a third embodiment of the connector assembly of the invention wherein the restraining element is resistively held in position on the body of the connector assembly of the invention and the restraining element encases a substantial portion of the body of the connector assembly of the invention; and

FIG. 4 is a perspective view of a tool useful in the method of the invention.

### DETAILED DESCRIPTION OF THE PREFERRED EMBODIMENTS

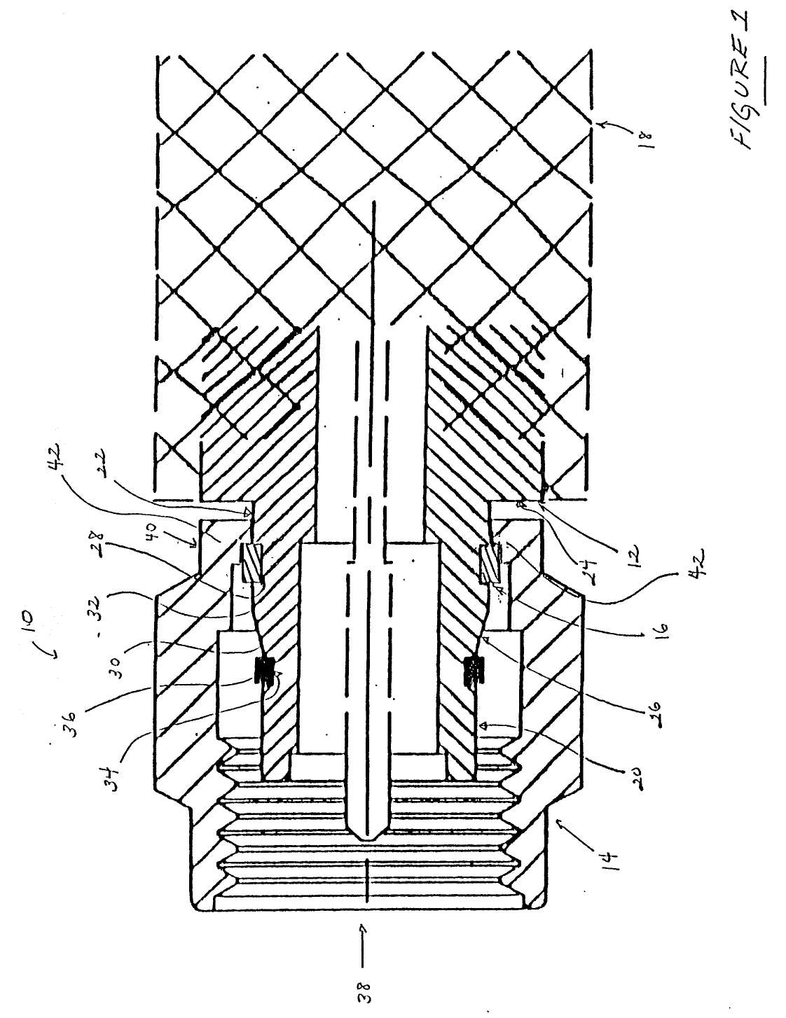

Referring now to FIGS. 1 through 3, there is shown a connector assembly 10 embodying the invention. The connector assembly of the invention 10 generally includes a body 12, a locking nut 14, and a restraining element 16. The body 12 provides a terminus for the wire or cable substrate 18 upon which the connector assembly of the invention 10 is positioned. The locking nut 14 provides a means for mechanically coupling the connector assembly of the invention 10 to a complementarily configured connector assembly. Finally, the restraining element 16 functions to secure and captively hold the locking nut 14 on the body 12.

Referring now to FIG. 1, it will be seen that the body 12 has two ends. More particularly, the body 12 has a first end 20 that is configured to be connected to another complementarily configured connector assembly. The second end 22 is affixed to a wire or cable substrate 18. The body 12 includes a ramp 26 and a groove element 28. The first end 20 of the body 12 typically has a cylindrical configuration. This configuration is desired as it facilitates rotatably securing the locking nut 14 in position on the body 12 in the manner described in detail below. The second end 22 also, typically, has a cylindrical configuration. Those skilled-in-the-art will appreciate, however, that the second end 22 of the body 12 can have virtually any cross-sectional configuration depending upon the application in which the connector assembly of the invention 10 is employed. The second end 22 of the body 12 typically has a cross-sectional dimension that is greater than the cross-sectional dimension of the first end 20. This increase in cross-sectional dimensions between the first end 20 and second end 22 creates a facing surface 24. The facing surface 24 cooperates with the restraining element 16 described below to secure the locking nut 14 rotatably in position on the body 12. The body 12 typically is manufactured from a metal substrate, however, virtually any material having the desired mechanical strength may be employed.

The ramp 26 may be located in close proximity to the terminus of the free end 20 of the body 12. Alternatively, as shown in FIG. 1, the ramp 26 may be located distal to the terminus of the free end 20 of the body 12. Preferably, the ramp 26 has a frusto-conical configuration. More particularly, the ramp 26 has a first portion 30 and a second portion 32. The first portion 30 of the ramp 26 preferably has a cross-sectional dimension that is less than the cross-sectional dimension of the second portion 32 of the ramp 26.

The groove element 28 is formed in the second portion 32 of the ramp 26. Preferably, the groove element 28 is dimensioned such that its cross-sectional dimension is intermediate the cross-sectional dimension of either the first portion 30 or the second portion 32. The groove element 28 has an external configuration complementary to the configuration of the restraining element 16 discussed in detail below.

If desired, as shown in FIG. 1, the body 12 may also include a second groove element 34. This second groove element 34 is typically located in close proximity to the terminus of the free end 20. The second groove element 34 is, preferably, positioned in advance of the first portion 30 of the ramp 26. The second groove element 34 preferably is configured to captively receive a washer 36. In operation, once positioned, the washer 36 functions to provide a watertight or gas-tight seal between the connector assembly of the invention 10 and the mating connector to which it is interconnected. The washer 36 also functions to prevent the migration of debris into the inner workings of the connector assembly of the invention 10.

As noted above, the locking nut 14 is rotatably secured on the body 12. The locking nut 14 typically provides an encasement for at least a portion of the free end 20 of the body 12. Typically, the locking nut 14 has a first open end 38 and a second closed end 40. Extending radially, inwardly from the second closed end 40 is a flange 42. As shown in FIG. 1, the flange 42 on the locking nut 14 interacts with the facing surface 24 of the body 12 and the restraining element 16 to rotatably secure the locking nut 14 in position on the body 12.

In the embodiment of the invention shown in FIG. 1, the restraining element 16 has an annular configuration. The restraining element 16 is formed from a substantially rigid, elastically deformable material for example, metal, plastic or rubber. The restraining element 16 preferably can be deformed from a relaxed state to an expanded state. The restraining element 16 retains, however, a memory of its relaxed state and, thus, returns toward that state when captured in the groove element 28. The cross-sectional configuration ofthe restraining element 16 is substantially identical to the external configuration of the first end 20 of the body 12. Preferably, the restraining element 16 is sized and shaped such that when it is in its relaxed state it can be received on the first portion 30 of the ramp 26 of the body 12. The restraining element 16 is slidable on and along the ramp 26 and, as it does so, the restraining element 16 typically expands from its relaxed state to its expanded state. As noted above, the restraining element 16 contracts back toward its relaxed state when it is moved into the groove element 28. Thus, when the connector assembly of the invention 10 is fully assembled the restraining element 16 is captively held in the groove element 28.

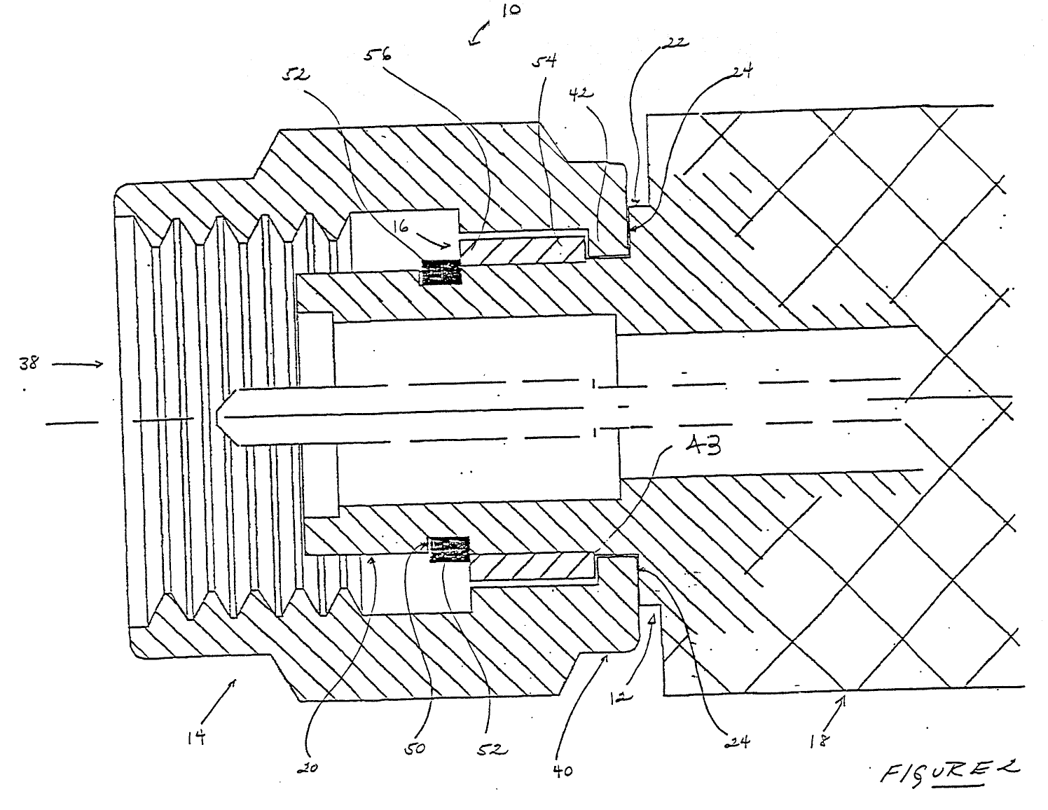

A second embodiment of the invention is depicted in FIG. 2. The configuration of the body 12 is substantially the same as that discussed in connection with FIG. 1. For example, the body 12 shown in FIG. 2 also has a first end 20, designed to be connected to another complementarily configured connector assembly, and a second end 22, which can be affixed to a wire or cable substrate 18. The body 12 of FIG. 2, however, has a substantially cylindrical configuration along its entire length. In the first instance, this substantially cylindrical configuration is desired as it facilitates rotatably securing the locking nut 14 in position on the body 12. This configuration is also desired as it permits resistively positioning the restraining element 16 on the body 12. The second end 22 has a cylindrical configuration. Those skilled-in-the-art will appreciate, however, that the second end 22 of the body 12 can have virtually any cross-sectional configuration depending upon the application in which the connector assembly of the invention 10 is employed. In the embodiment of the invention as shown in FIG. 2, the second end 22 of the body 12 typically also has a cross-sectional dimension that is greater than the cross-sectional dimension of the first end 20. This increase in cross-sectional dimensions between the first end 20 and second end 22 also creates a facing surface 24. Like the facing surface 24 of FIG. 1, the facing surface 24 of FIG. 2 cooperates with the restraining element 16 to secure the locking nut 14 in position on the body 12. The body 12 typically is manufactured from a metal substrate, however, virtually any material having the desired mechanical strength may be employed.

If desired, as shown in FIG. 2, the body 12 can include a groove element 50. When used, the groove element 50 is positioned such that it is located between the terminus of the free end 20 of the body 12 and a forward edge of the restraining element 16 as described in detail below. The groove element 50 is configured to receive a washer 52 having an annular configuration. The washer 52 typically has a myriad of functions. For example, the washer 52 often functions to assist in forming a watertight or gas-tight seal. The washer 52 can also function to prevent the migration of debris into the connector assembly of the invention 10. The washer 52 is generally annular in configuration and is formed from an elastically deformable substrate material, e.g., rubber or plastic, so that it may be easily positioned in the groove element 50.

The locking nut 14 is configured substantially identical to that described in connection with FIG. 1. The locking nut 14 has a first open end 38 and a second closed end 40. The open end 38 again provides a partial encasement for the body 12. Extending inwardly and radially from the second end 40 is a flange 42. The flange 42 cooperates with the restraining element 16 and a facing surface 43 formed in the body 12 to limit the travel of the restraining element as it is pushed onto the body so that the locking nut is freely rotatable when secured on the body.

The restraining element 16 utilized in connection with the embodiment of the invention shown in FIG. 2 has a configuration that is substantially identical to the external configuration of the body 12. Such similarity of configuration is required so that the restraining element 16 can be interferingly received on the body 12. Although this configuration of the restraining element 16 is typically annular, virtually any configuration can be used so long as it compliments the external configuration of the body 12 so that the restraining element and body can be frictionally engaged and fixed against relative movement. In the embodiment of the invention shown in FIG. 2, the restraining element 16 has a first portion 54 and a second portion 56. The first portion 54 of the restraining element 16 is configured to engage the flange 42 on the locking nut 14. In this way, the restraining element 16 serves to secure and captively hold the locking nut 14 in position on the body 12. That is, the locking nut 14 is captured between the first portion 54 of the restraining element 16 and the facing surface 24 of the body 12. The second portion 56 of the restraining element 16 abuts the washer 52. Operationally, this embodiment of the restraining element 16 is press-fitted onto the body such that the restraining element 16 and body 12 interferingly and resistively engage each other.

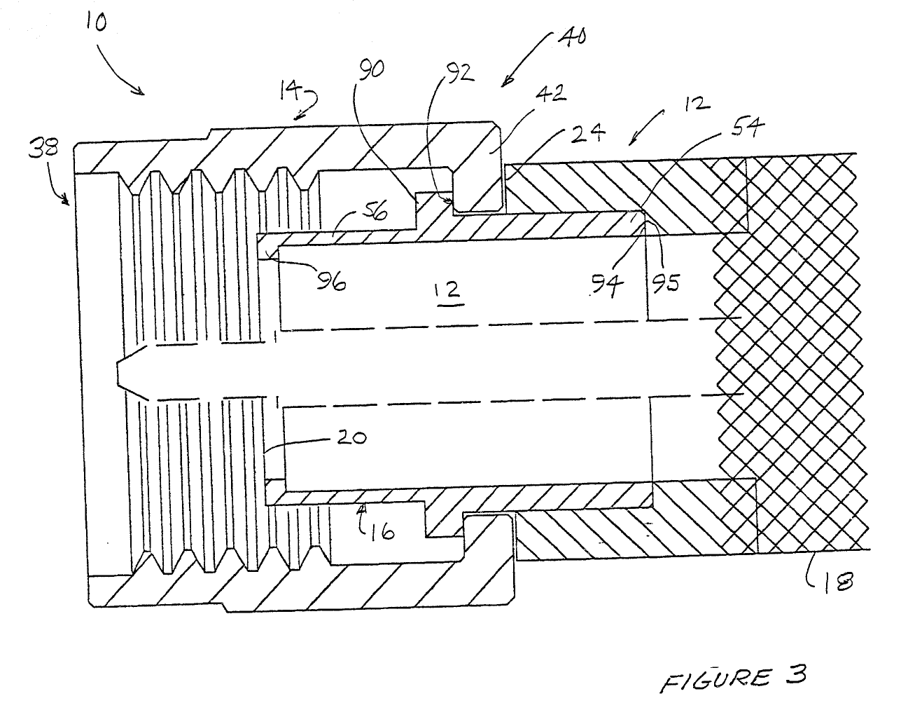

A third embodiment of the invention is depicted in FIG. 3. The configuration of the body 12 is substantially the same as that discussed in connection with FIGS. 1 and 2. For example, the body 12 shown in FIG. 3 also has a first end 20, designed to be connected to another complementarily configured connector assembly, and a second end 22, which can be affixed to a wire or cable substrate 18. The body 12 of FIG. 3, however, has a substantially cylindrical configuration along its entire length. The substantially cylindrical configuration is desired as it facilitates rotatably securing the locking nut 14 in position on the body 12 by permitting the resistive positioning of the restraining element 16 on the body 12. The second end 22 has a cylindrical configuration. Those skilled-in-the-art will appreciate, however, that the second end 22 of the body 12 can have virtually any cross-sectional configuration depending upon the application in which the connector assembly of the invention 10 is employed. In the embodiment of the invention as shown in FIG. 3, the second end 22 of the body 12 typically also has a cross-sectional dimension that is greater than the cross-sectional dimension of the first end 20. This increase in cross-sectional dimensions between the first end 20 and second end 22 also creates a facing surface 24. Like the facing surface 24 of FIGS. 1 and 2, the facing surface 24 of FIG. 3 cooperates with the restraining element 16 to secure the locking nut 14 in position on the body 12. The body 12 typically is manufactured from a metal substrate, however, virtually any material having the desired mechanical strength may be employed.

The locking nut 14 is configured substantially identical to that described in connection with FIGS. 1 and 2. The locking nut 14 has a first open end 38 and a second closed end 40. The open end 38 again provides a partial encasement for the body 12. Extending inwardly and radially from the second end 40 is a flange 42. The aperture created by the inwardly extending flange 42 is sufficient, however, to accommodate not only the free end 20 of the body 12 but the restraining element 16 as well. The flange 42 cooperates with the restraining element 16 and the facing surface 24 of the body 12 to secure the locking nut 14 in position.

The restraining element 16 utilized in connection with the embodiment of the invention shown in FIG. 3 has a configuration that is substantially identical to the external configuration of the body 12. Such similarity of configuration is required so that the restraining element 16 can be interferingly received on the body 12. Although this configuration of the restraining element 16 is typically cylindrical, virtually any configuration can be used so long as it compliments the external configuration of the body 12 so that the restraining element and body can be frictionally engaged or soldered together and fixed against relative movement.

In the embodiment of the invention, shown in FIG. 3, the restraining element 16 has a first portion 54 and a second portion 56. Operationally, this embodiment of the restraining element 16 is press-fitted onto the body such that the restraining element 16 and body 12 interferingly and resistively engage each other.

A section of the first portion 54 extends through the aperture created by the inwardly extending flange 42 of the locking nut 14 and abuts the body 12. Structurally, the first portion 54 of the restraining element 16 includes a flange 90. The flange includes a facing surface 92. The facing surface 92 is configured to engage an inner surface of the flange 42 on the locking nut 14. In this way, the restraining element 16 serves to secure the locking nut 14 in position on the body 12. That is, the locking nut 14 is captured between the facing surface 92 of the first portion 54 of the restraining element 16 and the facing surface 24 of the body 12. The first portion 54 also includes an end surface 94 configured to engage a facing surface 95 formed in the body 12. The end surface 94 facilitates proper seating of the restraining element 16 on the body 12.

The second portion 56 of the restraining element 16 includes a radially inwardly extending flange 96. The flange 96 is configured to engage the body 12. Like the end surface 94 of the first portion 54, the flange 96 of second portion 56 functions to assist in properly seating the restraining element 16 on the body 12.

The invention also contemplates a method for manufacturing the connector assembly ofthe invention 10. To commence the method of the invention shown in FIG. 1, a body 12, restraining element 16, and locking nut 14 having configurations as described above are obtained. The restraining element 16 utilized will, of course, depend upon the type of body 12 to be utilized in a given application. In the next step, the locking nut 14 is mounted on the body 12. The restraining element 16 is then coaxially and concentrically aligned with the front or free end of the body 12. To complete the method of the invention, restraining element 16 is pushed on and up ramp 30 until such time as the restraining element is received in groove 28, whereby locking nut 14 is rotatably restrained between the restraining means and facing surface 24 of body 12.

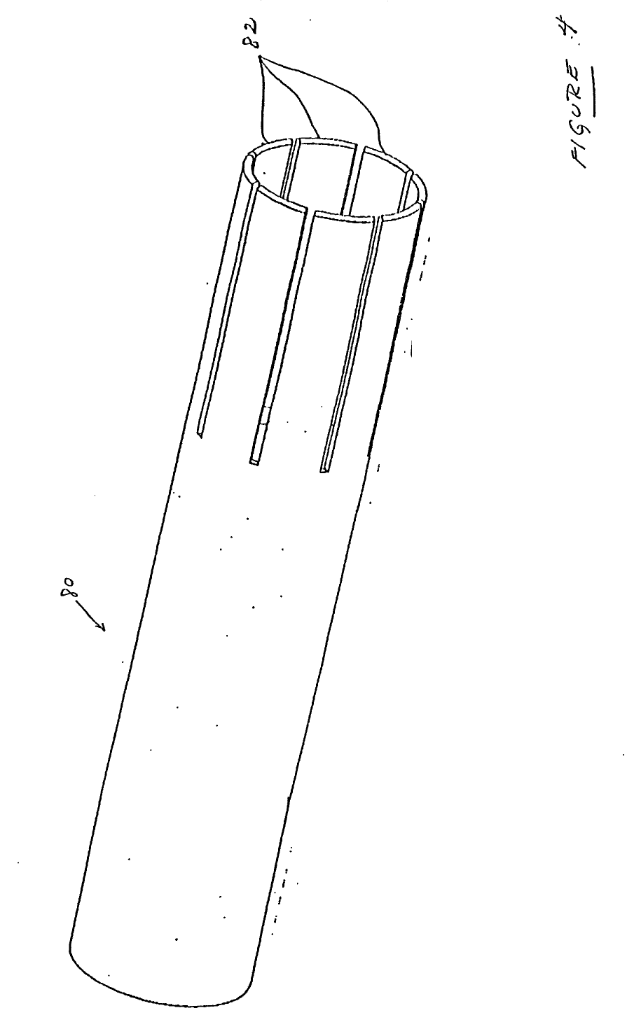

The method of the invention also contemplates the usage of a tool element 80 depicted in FIG. 4. The tool element 80 is configured to apply a selected force to the restraining element 16 so that the restraining element 16 is pushed with an even and consistent force axially onto the body 12. Typically, for use of tool 80 for installation of restraining element 16 in the embodiment of the invention shown in FIG. 1, tool 80 has a series of tangs 82. The tangs 82 flex outwardly as force is applied to the restraining element 16, and movement on and over the body 12 is effected. In this way, the tool 80 is able to move over the length of the body 12 without becoming bound onto the surface thereof.

The invention also contemplates a method for manufacturing the connector assembly of the invention 10 shown in FIG. 2. To commence the method of the invention shown in FIG. 2, a body 12, restraining element 16, and locking nut 14 having configurations as described above are obtained. The restraining element 16 utilized will, of course, depend upon the type of body 12 to be utilized in a given application. In the next step, the locking nut 14 is mounted on the body 12. The restraining element 16 is then coaxially and concentrically aligned with the front or free end of the body 12. To complete the method of the invention, the restraining element 16 is pushed onto the body 12 until it engages the facing surface 43. Restraining element 16 and body 12 are in tight frictional engagement and constrained against relative movement. Locking nut 14 is rotatably restrained between the restraining means 16 and the facing surface 24 of the body 12.

The invention also contemplates a method for manufacturing the connector assembly of the invention 10 shown in FIG. 3. To commence the method of the invention shown in FIG. 3, a body 12, restraining element 16, and locking nut 14 having configurations as described above are obtained. The restraining element 16 utilized will, of course, depend upon the type of body 12 to be utilized in a given application. In the next step, the locking nut 14 is mounted on the restraining element 16. The restraining element 16 is then coaxially and concentrically aligned with the front or free end of the body 12. To complete the method of the invention, the restraining element 16 is pushed onto the body 12 until it engages the facing surface 95. Restraining element 16 and body 12 are in tight frictional engagement or soldered together and constrained against relative movement. Locking nut 14 is rotatably restrained between the facing surface 92 ofthe restraining means 16 and the facing surface 24 of the body 12.

It will be understood that changes may be made in the above construction and in the foregoing sequences of operation without departing from the scope of the invention. It is accordingly intended that all matter contained in the above description or shown in the accompanying drawings be interpreted as illustrative rather than in a limiting sense.

It is also to be understood that the following claims are intended to cover all of the generic and specific features of the invention as described herein, and all statements of the scope of the invention which, as a matter of language, might be said to fall there between.

What is claimed is:

1. A connector assembly adapted to be matingly engagable with, and disengagable from, a complementary connector, said connector assembly comprising:
(a) a body, said body having a free end;
(b) a locking nut rotatably received on said body;
(c) a restraining means for restraining said locking nut on said body, said restraining means being elastically deformable from a first relaxed state to a second expanded state;
(d) said body including a ramp having a frusto-conical configuration, said ramp having a first portion and a second portion, said first portion being smaller than said second portion, said first portion being formed at in said free end of said body, a groove means formed in said second portion of said ramp, said restraining means being sized and shaped to be received on said first portion when in said relaxed state, said restraining means being slidable on and along said ramp, said restraining means moving from said first relaxed state to said second expanded state when said restraining means is slidably moved on said ramp from said first portion toward said second portion, said restraining means being captively held in said groove means, said locking nut being restrained for rotatable movement on said body by said captively held restraining means.

2. The connector assembly of claim 1 wherein said restraining means has an annular configuration.

3. The connector assembly of claim 1 wherein said restraining means contracts from said second expanded state toward said first relaxed state when said restraining means is moved into said groove in said second portion of said ramp means.

4. The connector assembly of claim 1 wherein said first portion of said ramp means has a first cross-sectional dimension and said second portion of said ramp means has a second cross-sectional dimension, said first dimension being less than said second dimension, said groove means having a third cross-sectional dimension, said third cross-sectional dimension of said groove means being less than said second dimension.

5. A connector assembly adapted to be matingly engagable with, and disengagable from, a complementary connector, said connector assembly comprising:
(a) a body, said body having a selected configuration;
(b) a locking nut positioned on said body, said locking nut having an inwardly extending flange; and
(c) a restraining means for restraining said locking nut on said body, said restraining means configured to mate with said body in frictional locking engagement, said restraining means having a portion that engages said inwardly extending flange of said locking nut for captively holding said locking nut on said body;
(d) said body interferingly receiving said restraining means such that said locking nut is rotatably secured on said body when said restraining means is in frictionally locked engagement with said body, said flange of said locking nut being rotatably captured between said body and said restraining means.

6. The connector assembly of claim 5 wherein said restraining means is a sleeve having a substantially circular cross-sectional configuration that is substantially annular.

7. The connector assembly of claim 6 wherein said body has a selected cross-sectional dimension and said restraining means has a selected cross-sectional inner dimension, said cross-sectional dimension of said body and said cross-sectional inner dimension of said restraining means being selected such that said restraining means is resistably movable over and along said body.

8. The connector assembly of claim 5 wherein said body further comprises a groove means.

9. The connector assembly of claim 8 further comprising a washer means, said washer means being sized and shaped to be positionable in said groove means.

10. The connector assembly of claim 9 wherein said washer means has an annular configuration.

11. The connector assembly of claim 10 wherein said washer means is elastically deformable between a first relaxed state and a second expanded state, said washer means expanding from said first relaxed state to said second expanded state when washer means is moved along said body, said washer means contracting from said second expanded state to said first relaxed state when said washer means is positioned in said groove means.

12. A method for assembling a connector assembly adapted to be matingly engagable with, and disengagable from, a complementary connector, said method comprising the steps of:
(a) providing a body having a free front end;
(b) providing a locking nut sized and shaped to be positionable on said body;
(c) providing a restraining means for restraining said locking nut on said body;
(d) mounting said locking nut on said free front end of said body;
(e) aligning said restraining means with said body such that said restraining means and said body are coaxially and concentrically aligned relative to each other;
(f) pushing said restraining means from a front free end of said body along and over said body until said locking nut is restrained between said restraining means and said body.

13. The method of claim 12 wherein said step of providing said restraining means includes the step of providing a restraining means having an annular configuration.

14. The method of claim 13 wherein said step of providing said body includes the step of providing a body having a ramp and a groove, said ramp having a frusto-conical configuration, said ramp having a first portion and a second portion, said first portion of said ramp being sized to slidably receive said restraining means, said second portion being sized to resistively engage said restraining means, said second portion of said ramp deformably enlarging said restraining means when said restraining means is moved on and over said second portion, said second portion of said ramp being in juxtaposition to said groove, said groove being configured to interferingly receive said restraining means.

15. The method of claim 14 wherein said step of providing said restraining means includes the step of providing a restraining means that is expandable and contractible between a first contracted state and a second expanded state, said restraining means expanding from said first contracted state to said second expanded state when said means for restraining said locking nut on said body is moved along said second portion of said ramp, said restraining means contracting from said second expanded state to said first contracted state when said restraining means is moved from said second portion of said ramp to said groove.

16. The method of claim 15 wherein said step of providing said locking nut includes the step of providing a locking nut having an inwardly extending flange.

17. The method of claim 16 wherein said step of providing said restraining means includes the step of providing a restraining means that has a portion configured to slidably engage said inwardly extending flange of said locking nut.

18. The method of claim 17 wherein said step of providing said body further includes the step of providing a body that interferingly receives said restraining means, said flange of said locking nut being rotatably captured between said body and said restraining means.

19. The method of claim 18 further including the step of providing a tool means, said tool means being configured to apply a selected force to said means for restraining said locking nut on said body so as to push said means for restraining said locking nut on said body along and over said body.
